(19) United States
(12) Patent Application Publication
(10) Pub. No.: US 2016/0364948 A1
(43) Pub. Date: Dec. 15, 2016

(54) GAMING DEVICE AND GAME METHOD HAVING A BLOCK WILD FEATURE

(71) Applicant: Gemini Digital Development, Inc., Las Vegas, NV (US)

(72) Inventors: Robert Parviainen, Santa Monica, CA (US); James P. Jackson, Henderson, NV (US)

(21) Appl. No.: 15/181,265

(22) Filed: Jun. 13, 2016

Related U.S. Application Data
(60) Provisional application No. 62/174,364, filed on Jun. 11, 2015.

(51) Int. Cl. G07F 17/32; G07F 17/34

(52) U.S. Cl. CPC G07F 17/3227; G07F 17/3211; G07F 17/3258; G07F 17/3267; G07F 17/3246; G07F 17/3209; G07F 17/34; G07F 17/3248

(57) ABSTRACT

A method of presenting a game at a gaming machine including accepting a wager from a player via the wager accepting device, displaying a plurality of symbols in an array of symbols on the electronic display, the array of symbols comprising symbol positions aligned in rows and columns, and determining whether two or more of the plurality of symbols displayed in the array of symbols are the same symbol and are disposed adjacent to one another defining a common symbol block. When the two or more of the plurality of symbols define a common symbol block, replacing the two or more symbols with a first replacement symbol, and evaluating pay lines on the array of symbols to determine whether the array of symbols including the first replacement symbols define winning outcomes.

### CROSS-REFERENCE TO RELATED APPLICATION

This application claims priority to U.S. Provisional Application No. 62/174,364 which was filed on Jun. 11, 2015, the contents of which are hereby incorporated by reference.

### BACKGROUND

This document describes a gaming machine and a method of gaming with a new game feature, and in particular to a method and apparatus for a wagering game with a block wild feature.

Slot type games and gaming machines are well known. Early slot machines were mechanically operated. These machines included a plurality of physical reels which had symbols printed on them. The reels were mechanically rotated and the outcome of the game was determined by the symbols which were displayed when the reels came to a stop.

Later, electronically operated slot machines were developed. A first type of electronically operated slot machine still utilizes physical reels. However, the reels are rotated by motors and those reels are stopped at positions corresponding to a determined outcome. A second type of electronically operated slot machine displays representations of spinning reels graphically on a video display. In both cases, a game outcome is selected and then the reels (physical or video represented) are stopped at a position which displays that outcome.

A number of methods have been devised for selecting the outcome of a slot type game and then controlling the reels or generating graphics to display the selected outcome. However, existing methods have been determined to have practical or technological drawbacks. These drawbacks include high game volatility (such as where winning outcomes may be separated by long stretches of losing outcomes) or the requirement of significant processing and data storage/memory (thus increasing the game development or presentation time and a higher gaming machine cost). Further, over time, players lose interest in slot machine games due to the appearance of being old fashioned and not including the latest gaming features.

Gaming operators thus seek to increase patronage to their gaming establishments by providing the newest, most exciting, and most interest game features in their gaming establishments. Accordingly, it is desirable that new and interesting game features be developed to attract players to gaming establishments. Thus a new and improved method of generating game outcomes is desired.

### SUMMARY

According to some embodiments of the invention, a method of presenting a game at a gaming machine is provided. The gaming machine may comprise at least one electronic display, a wager accepting device configured to accept a physical item representing a monetary value, at least one input device, at least one memory, and at least one processor configured to execute machine readable instructions stored on the memory.

The method may include accepting a wager from a player via the wager accepting device, displaying a plurality of symbols in an array of symbols on the electronic display, the array of symbols comprising symbol positions aligned in rows and columns, and determining whether two or more of the plurality of symbols displayed in the array of symbols are the same symbol and are disposed adjacent to one another defining a common symbol block.

When the two or more of the plurality of symbols define a common symbol block, the two or more symbols are replaced with a first replacement symbol, and pay lines on the array of symbols are evaluated to determine whether the array of symbols including the first replacement symbols define winning outcomes.

In some embodiments, the first replacement symbol is a wild symbol. The common symbol block may be defined by the same symbols that are adjacent to one another in a horizontal and vertical direction in the array. In some instances, the two or more symbols defining a common symbol block trigger a secondary event comprising at least one of a bonus game, a progressive jackpot, and one or more free spins.

When the two or more symbols define a common symbol block, the two or more symbols may be held in the array and the remaining symbols within the array may be re-spun to randomize the remaining symbols from the plurality of symbols. The remaining symbols may then be reevaluated to determine if the remaining symbols comprise the same symbol adjacent to the common symbol block. When this occurs the same symbol adjacent to the common symbol block is added to the common symbol block.

In further embodiments, when the two or more symbols do not define the common symbol block, an input from the player may be received to change a selected symbol from the displayed plurality of symbols into a different symbol. This may allow the player to form a common symbol block where one did not previously exist.

In some instances, when two or more common symbol blocks are formed in the array, the two or more common symbol blocks are moved to form a single common symbol block. In one embodiment, when the two or more symbols define the common symbol block, a size of the array of symbols is increased. For example, the size of the array of symbols may increase in a vertical direction corresponding to the location of the common symbol block. In another embodiment, the display shows the two or more symbols connecting to appear as a continuous symbol.

According to another embodiment, a method of presenting a game comprises accepting a wager from a player via the wager accepting device and displaying a plurality of symbols in an array of symbols on the electronic display. The array of symbols may include symbol positions aligned in rows and columns, and the plurality of symbols may include a primary value and a secondary design.

It may be determined whether two or more of the plurality of symbols displayed in the array of symbols are disposed adjacent to one another such that a combination of the secondary design of the two or more symbols forms a predetermined image. When the two or more of the plurality of symbols form the predetermined image, the two or more symbols are replaced with a first replacement symbol. Pay lines are evaluated on the array of symbols to determine whether the array of symbols including the first replacement symbols define winning outcomes.

In some embodiments, the first replacement symbol is a wild symbol. The two or more symbols defining the predetermined image may comprise different primary values. The two or more symbols the predetermined image may trigger a secondary event comprising at least one of a bonus game, a progressive jackpot, and one or more free spins.

In some instances, when the two or more symbols do not form the predetermined image, an input from the player is received to change a selected symbol from the displayed plurality of symbols into a different symbol. In one implementation, when two or more predetermined images are formed in the array, the two or more predetermined images are moved to form a single image.

When the two or more symbols form the predetermined image, a size of the array of symbols may be increased. For example, the size of the array of symbols may be increased in a vertical direction corresponding to the location of the predetermined image. The display may show the two or more symbols connecting to appear as a continuous symbol.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 illustrates an example array of symbol locations displayed on a screen of a gaming machine.

FIG. 2A, FIG. 2B, FIG. 2C, FIG. 2D, and FIG. 2E illustrate exemplary symbol arrangements

FIG. 3A illustrates an example symbol array of 5×3 dimension, and FIG. 3B illustrates an example of a transformation of the symbol array shown in FIG. 3A.

FIG. 4A shows a screen with an array of symbols including a contiguous block of symbols according to one exemplary embodiment, and FIG. 4B shows a screen with an array of symbols including a contiguous block of symbols and wild symbols according to one exemplary embodiment.

FIG. 5A shows a screen with an array of symbols including a contiguous block of symbols according to one exemplary embodiment, and FIG. 5B shows a screen with an array of symbols including a contiguous block of symbols and a wild symbol according to one exemplary embodiment.

FIG. 6 shows one configuration of a gaming machine according to an exemplary embodiment.

FIG. 7 is an exemplary networked gaming system configured to implement the method disclosed herein.

FIG. 8 is an exemplary computer or mobile device or portion of gaming machine.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

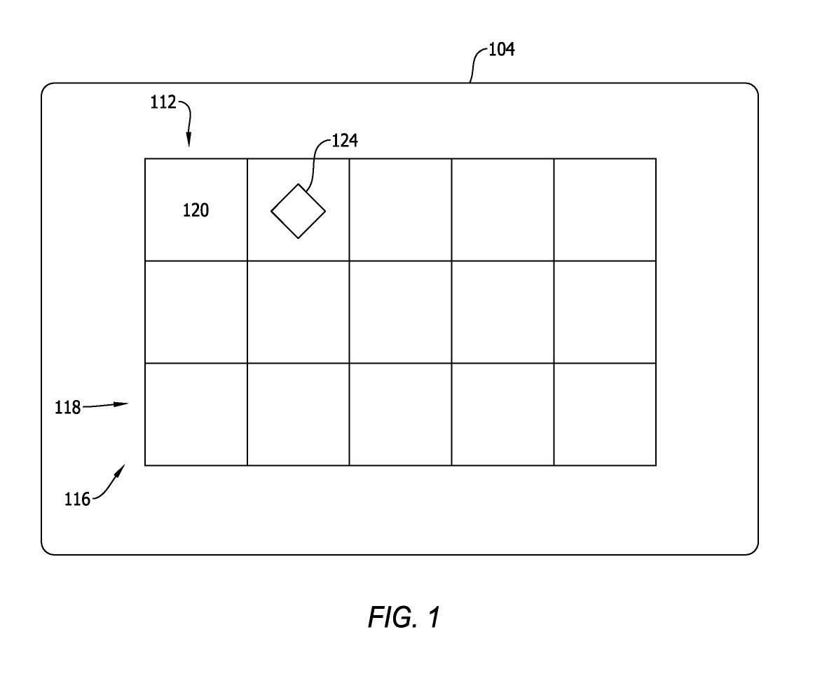

According to one embodiment, a game feature includes an array of symbol locations. FIG. 1 illustrates an example array of symbol locations displayed on a screen 104 of a gaming machine. As shown, the array 116 is 5×3 but in other embodiment arrays may include any number of other sizes or configurations. For example, in some embodiments, the array may be in a configuration other than a square or rectangular configuration.

The array 116 comprises symbol locations 120 that display symbols 124. The symbols may be arranged in rows 118 and columns 112 such that the standard symbols occur in singles, stacks of two and stacks of three on the reels (displayed in columns 112). In one example embodiment, 5×3 array is provided with a fixed bet of 40 credits for 40 lines, but other arrays and bet configurations are possible. Because there may be multiple play lines associated with the array, this game method and apparatus is contemplated for use with multiple pay lines or with multiway mechanics.

On multiway games, players play the entire position of each reel instead of fixed lines or patterns. For instance, if a player plays 1 reel on a 243 way game, they receive three symbols in the first reel which pay anywhere in the three positions, while all other reels pay in the center only, with unused areas darkened. On the other end of the scale, if the player plays 5 reels, symbols can appear anywhere in the window and will pay as long as there is one in each reel. Most games however still require the symbols appearing left to right, sometimes also including scatters. Other multiway games provide even more ways by using a 5×4 or 5×5 pattern, where there are up to 5 symbols in each reel, allowing for up to 1,024 and 3,125 ways to win respectively.

During game play, the player wagers (bets) to participate in the wagering game. The player then activates the game and in a typical manner, such as via an input device to trigger a spin of the reels. The screen 104 is controlled by the gaming machine software and/or hardware to display rows 118 and columns 112 of symbols in an array. The columns 112 may be considered as displaying portions of the reels with different reel positions displaying different symbols. Any symbol art may be used.

As shown in FIG. 1, certain symbol locations 120 touch or are adjacent to other symbol locations 120 while other symbol locations 120 only touch at the corners or do not touch at all (are not adjacent on a side or corner). After the initial group of symbols 124 are displayed, analysis occurs on the displayed array of symbols 124 to determine if contiguous (sharing a side) symbols 124 are of the same symbol type (cherry-cherry, or diamond-diamond). In one embodiment, randomly, periodically, or every time a contiguous group of four or more of the same symbol 124 appears on the reels, those contiguous group of symbols 124 change or are swapped to wild symbols. This adds player excitement by adding random wild symbols to the array of symbols 116 to increase the player's chance of winning and increases the number of wild symbols, which is a desirable outcome in reel based wagering games.

In this example embodiment, the number of contiguous symbols is four. It is contemplated that in other embodiments a greater number or a lesser number of contiguous symbols may be required to transform the contiguous symbols to wild symbols. In one configuration, the wager may determine or be a factor in the number of contiguous symbols required to trigger a non-wild symbol to wild symbol conversion. In one example embodiment, the regular symbols may occur in singles, or stacks of 2 or 3 high on the reels. In other embodiments, other symbol stack heights may be presented to the player. In the event free spins occur, free spins may be triggered, and more stacks may occur on the free spin reels. These additional stacks may also undergo analysis and replacement with wild symbols for contiguous identical symbols.

It is further contemplated that instead of wild symbols, the contiguous system may be transformed or replaced with another non-wild symbol.

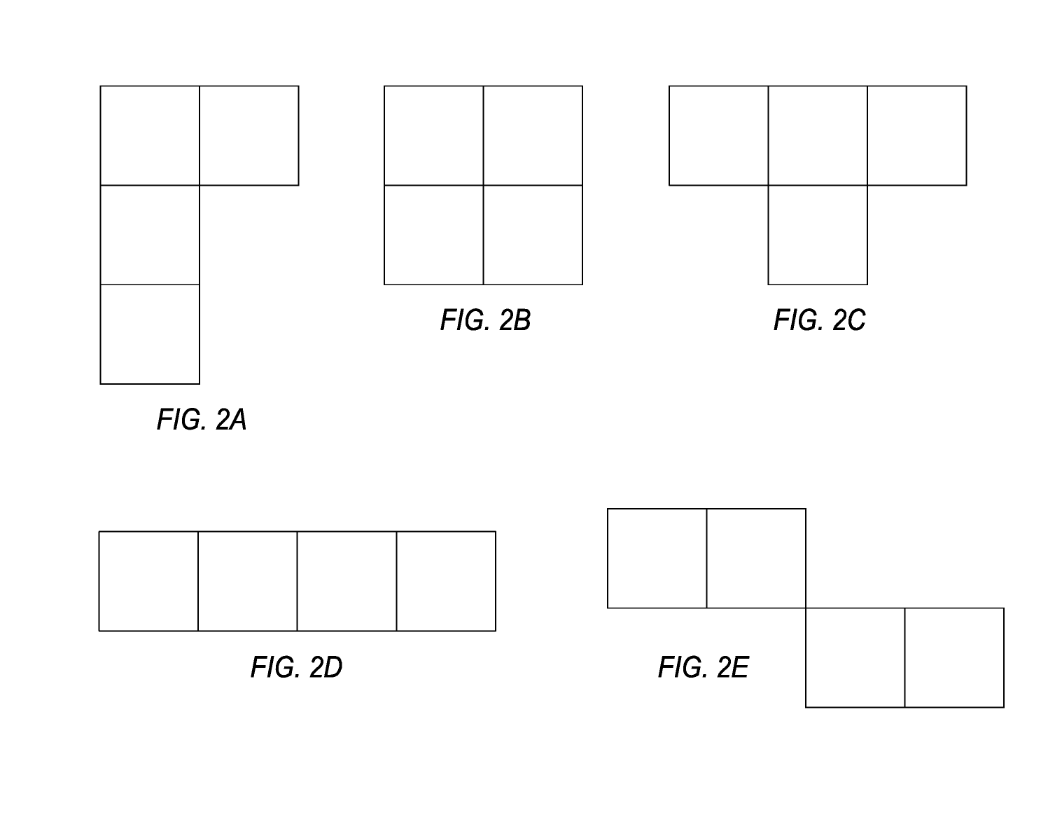

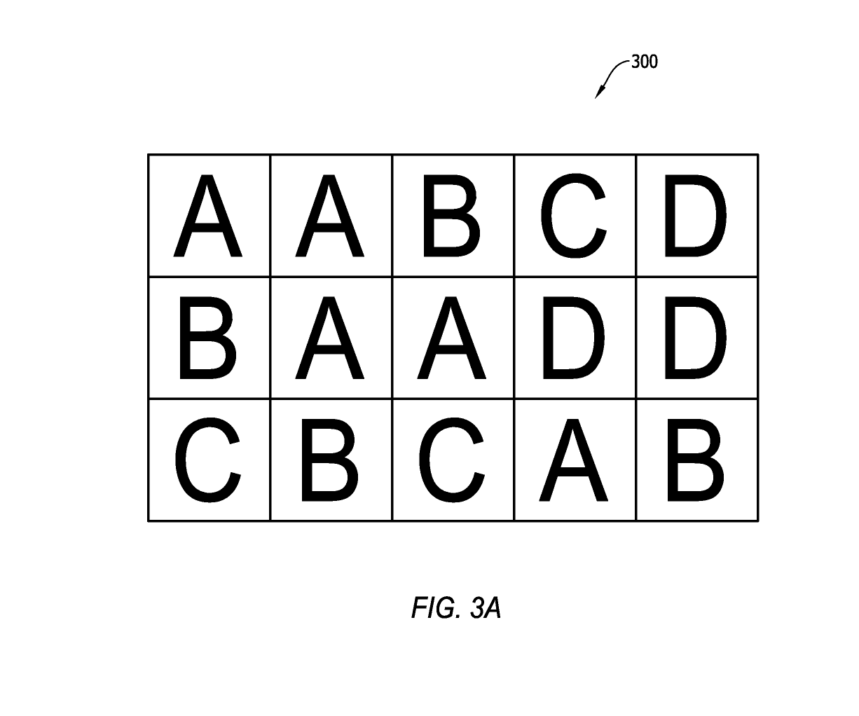

FIGS. 2A-2E illustrate exemplary contiguous symbol arrangements. In one embodiment, for the symbols to be contiguous, the symbol group (two symbols) need to share at least one edge to be considered “contiguous”. For example, FIGS. 2A-2D shows possible “contiguous groups” that would convert to wild symbols. FIG. 2E illustrates a non-contiguous group of symbols because the sides of four consecutive identical symbols are not touching. Instead there are only two blocks of two identical contiguous symbols with adjacent or touching sides. However, in some instances, where there are two contiguous group that touch only at a corner, the two groups may transform into a contiguous group by moving one of the groups to be adjacent to the other.

In one embodiment, symbols that are wild prior to conversion of contiguous group symbols do not count for completing a contiguous group of symbols and only affect win evaluation after the spin has completed. In other embodiments, any symbols which are contiguous whether wild or not, may be used to create additional groups of contiguous symbols. It is also contemplated that only a particular preselected or user selected symbol type (diamond, cherry) may be the only type symbol which undergoes contiguous analysis and conversion to a wild symbol.

In one embodiment, the game also incorporates a ‘free spin bonus’. A free spin bonus is defined here such that during the free spin bonus, an additional two or three (or any number) symbol stacks are placed on the reels to increase the frequency of the Wild conversion feature. By placing the additional symbol stacks on the reels, there are additional symbol location in the array, and thus there is a higher likelihood that a group (of a predefined number) of contiguous symbols will be established, and thus converted to wild symbols. Consequently, as a result of increasing the number of wild symbols, there is an increased likelihood of the player receiving a winning outcome.

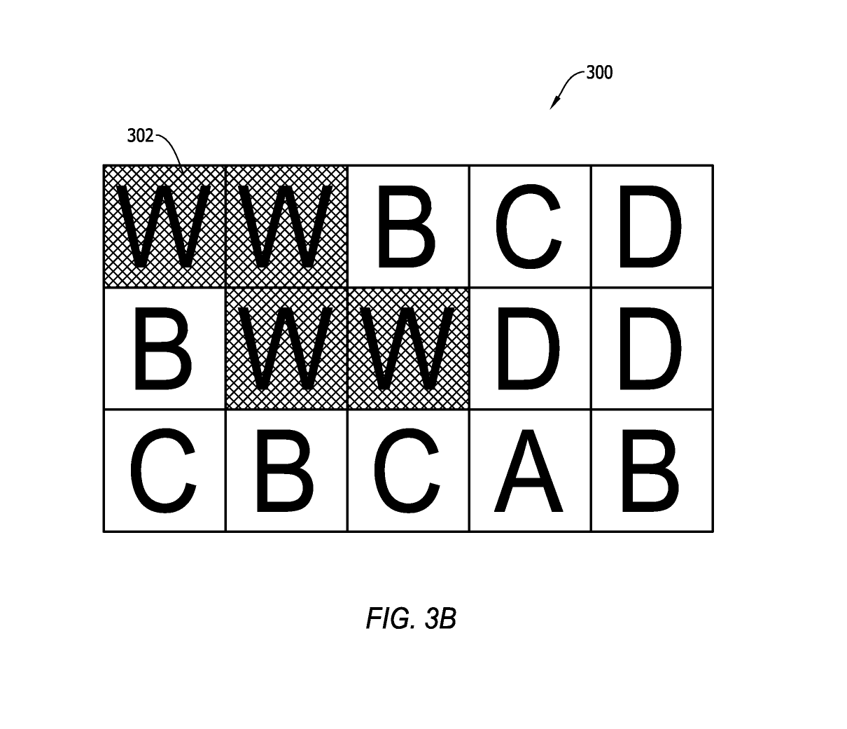

FIG. 3A illustrates an example symbol array 300 of 5×3 dimension. Symbols are represented by capital letters A, B, C & D. In this embodiment, symbol A shown at the array locations form a block of four contiguous symbol locations. Thus, during the symbol conversion process the array of symbols transforms to that shown in FIG. 3B. As shown in FIG. 3B, the array 300 has the block 302 of four contiguous symbols transformed to wild symbols shown as capital W.

### Example Statistics

The following are exemplary statistics for one possible realization of 88% return to player math. In other embodiments, other percentages may be used and the following game parameters may also change. In this example, embodiment, the following factors are part of the game.

RTP 88%

Hit Rate 34%

Volatility Low-Medium

Free Spin Feature RTP (frequency) 20% (1 in 120 spins)

Block Wilds Feature Frequency 1 in 17 spins

Block Wilds Feature Win Rate 80%

Proportion with 4 wilds (features/spins) 80%/4.8%

Proportion with 5 wilds 16%/1%

Proportion with 6 or more wilds 2.5%/0.15%

### Variations

Many variations of the basic feature or in addition to the basic feature are possible. These variations may be arranged alone or in any combination.

Re-Spin after Symbol Replacement

In one variation, after the transformation of multiple contiguous blocks turn wild (or turn to some other predetermined symbol), the symbols are held in place and a re-spin of the remaining symbols occur. If an additional group of contiguous symbols result from the re-spin, those symbols will also be transformed to Wild symbols (or to some other predetermined symbol).

### Re-Spin Before Symbol Replacement

In one variation, a block of symbols of a predetermined size are held for a re-spin but are only transformed to a Wild symbol after the re-spin(s) are finished. If blocks of a given size are found on a regular spin, these (and possibly any other occurrences of the same symbol on the reels) are held, and the purpose of the re-spin is to build up the region by landing further like symbols adjacent to those existing after the first spin of the reels.

### Contiguous Block Determine Secondary Events

It is also contemplated that blocks of continuous blocks could be used to trigger bonuses, credit awards, or progressive jackpots. In one embodiment, trigger symbols are stacked on the reels and a block of given minimal size is needed to trigger the transformation to Wild symbols. As a result, larger or bigger blocks give more re-spins to the player and thus result in higher awards for the player.

### Contiguous Block Size Adjustment

In yet another variation, blocks can be allowed to “grow” during a re-spin where Wild symbols adjacent may be added to the block or lower valued symbols adjacent to the blocks are upgraded to the same block symbol. Thus, the size of the block may be adjusted upward to increase the block size during a re-spin. The player may also be given one free block change which may be selected by the player. In this way, the player may select one block to transform to create a better reel display or to create a contiguous block of identical symbols which will be turned to Wild symbols. In other embodiments, when a contiguous block could be formed by changing one or more symbols, the game may be configured such that the symbol changes automatically without player input.

### Complementary Contiguous Block Fitment

It is also contemplated that complementary blocks (symbol locations) within the array could move and “fit” together to create larger blocks. In one embodiment, the complementary blocks would have to form perfect squares in order to “fit” (for example, a “T” block of symbols matching up to a “U” shaped block) but linked or connected (squished together) blocks could then form large H1-type symbols or large Wild or Feature symbols. If blocks “move” they could uncover a secondary set of symbols that exist beneath. These newly revealed symbols could be clones of the symbols that moved or they could be new symbols that are of no less value than the symbol that moved. Mathematically, it can be ensured that any symbols that moves to create “super blocks” would not leave behind symbols that would be detrimental to the player or create a result that is less valuable to the player than if the original symbols did not move.

### Increasing Height of Array Based on Contiguous Block

In one variation the array for the reels increases in height or width based on a continuous block. For example, if the base array is a 5×4 (4-4-4-4-4) array, and reel 2 splits due to a contiguous block on the display, the resulting array would be 4-5-5-4-4-4, and not 4-4-4-4-4-4, and pays would be evaluated using all possible 6400=4*5*5*4*4*4 ways. Instead of each occurrence one reel is split, the feature may be enhanced so that two or more of the reels are split.

### Symbol Triggers

Instead of triggering the feature using a random trigger, it is contemplated that special or predefined symbols on the regular reels may be used to define when a symbol, which are continuous, will be changed to wild symbols.

All Ways Vs. Pay Lines

The basic feature is designed to work well with all ways (a.k.a. any ways) pay evaluation, but it can also work with regular pay lines by incorporating multiple sets of pay lines, one for each possible array.

### Cascading Blocks

In some embodiments, the contiguous block of symbols may result in a cascading effect. For example, after the reels stop spinning and a contiguous block of symbols is identified, the contiguous block of symbols may be changed to wild symbols or other symbols, and it is determined if there are any resulting winning outcomes. After the determination for winning outcomes, the contiguous block of symbols may be removed, and symbols on the reels above of the contiguous block of symbols may appear to slide down to fill in the symbol positions vacated by the contiguous block. Thereafter, it is determined if there are any additional contiguous blocks of symbols and/or winning outcomes. This process may repeat until no other contiguous blocks or winning outcomes are present.

### Connecting Symbols

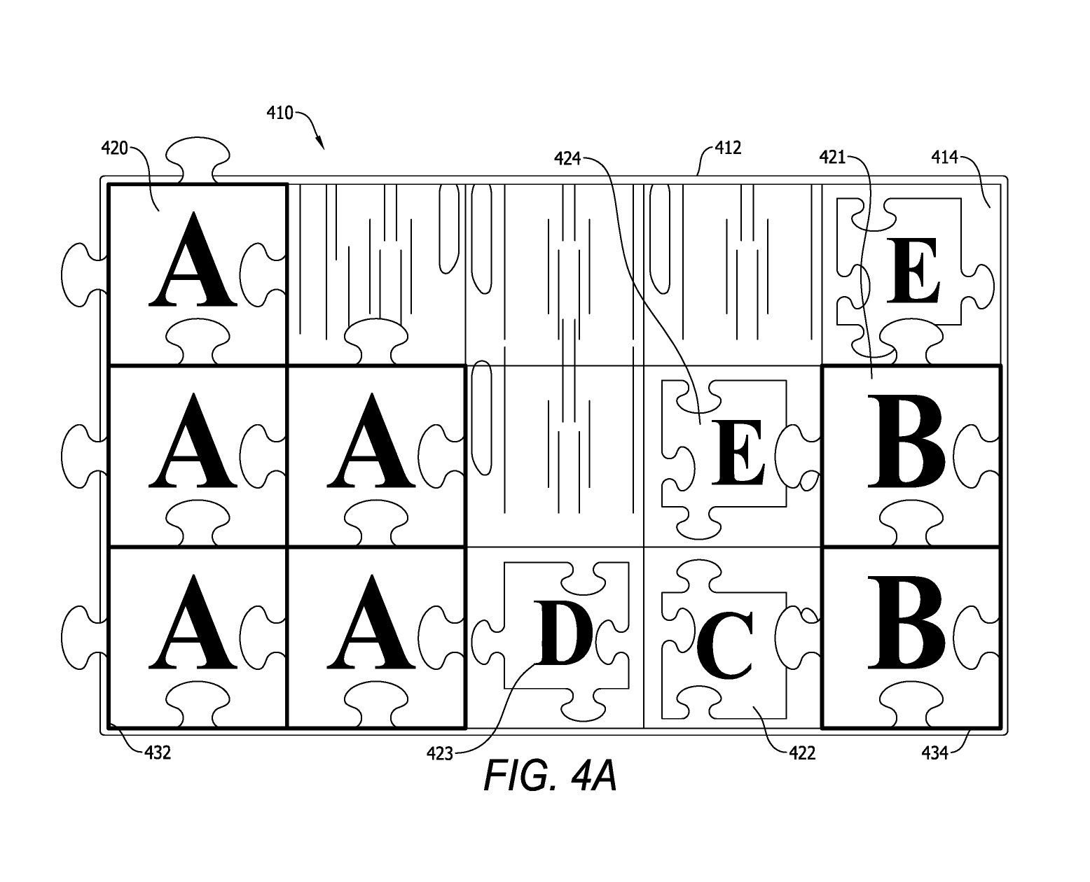

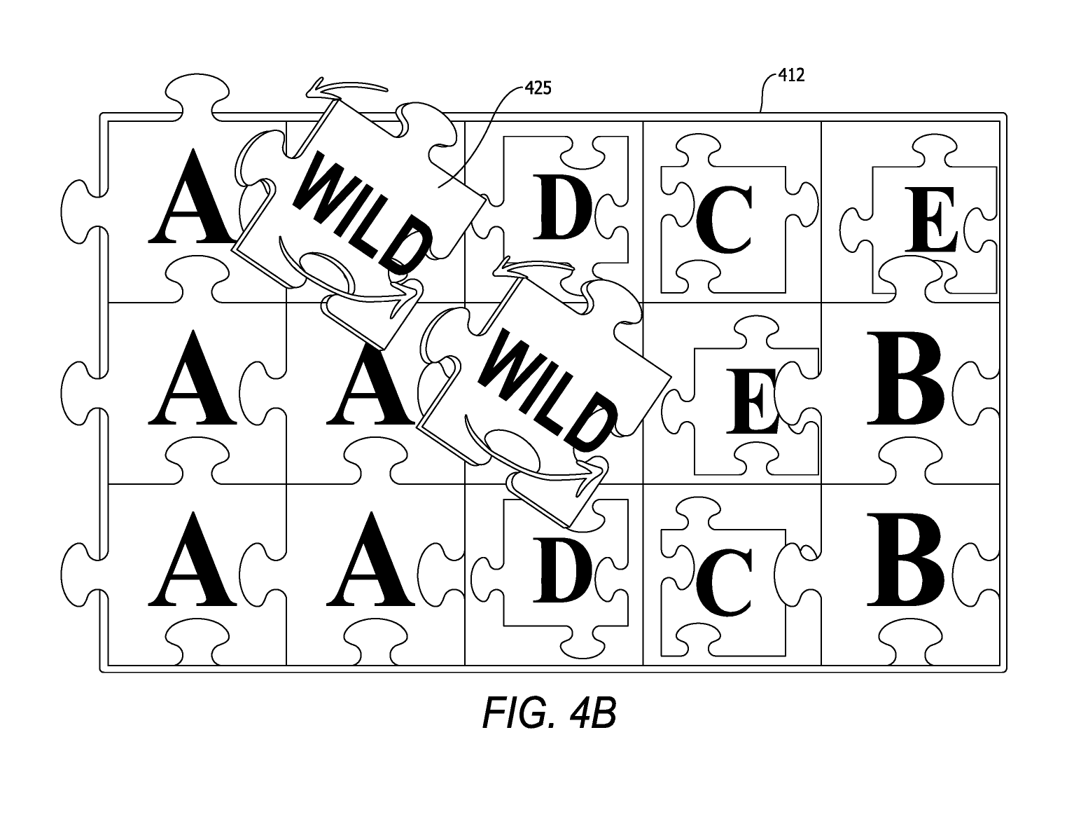

In another embodiment of the invention, the contiguous block of symbols may itself form into a single image. FIG. 4A shows a screen with an array of symbols including a contiguous block of symbols according to one exemplary embodiment. In FIG. 4A, there is a screen 410 that includes an array 412 of symbols positions 414. In this embodiment, the symbols in the array 412 are shaped as various puzzle pieces. Here, the symbols may include puzzle piece A 420, puzzle piece B 421, puzzle piece C 422, puzzle piece D 423, and puzzle piece E 424. As shown in FIG. 4A, the different types of puzzle pieces are shown to have a shape that connects to other symbols of the same type. That is puzzle piece A 420 connects to other As 420, puzzle piece B 421 connects to other Bs 421, etc.

Accordingly, when a number of the same symbols are disposed adjacent to one another as a result of a spin, the symbols may be animated to attach to the adjacent symbols to form contiguous blocks of symbols. In FIG. 4A, block 432 is formed by A symbols 420 and the A symbols 420 are shown to have connected to one another. Similarly, block 434 is formed by B symbols 421 attaching together. When the symbols form a block in this instance, the block may appear as one continuous image. Further, in some embodiments, the individual markings of the symbols may be replaced with a single marking on the combined block of symbols.

FIG. 4B shows a screen with an array of symbols including a contiguous block of symbols and wild symbols according to one exemplary embodiment. In some embodiments, wild symbols may also be included in the array 412. The wild symbols may be animated to also attach to the block of symbols to form a single image of a larger symbol.

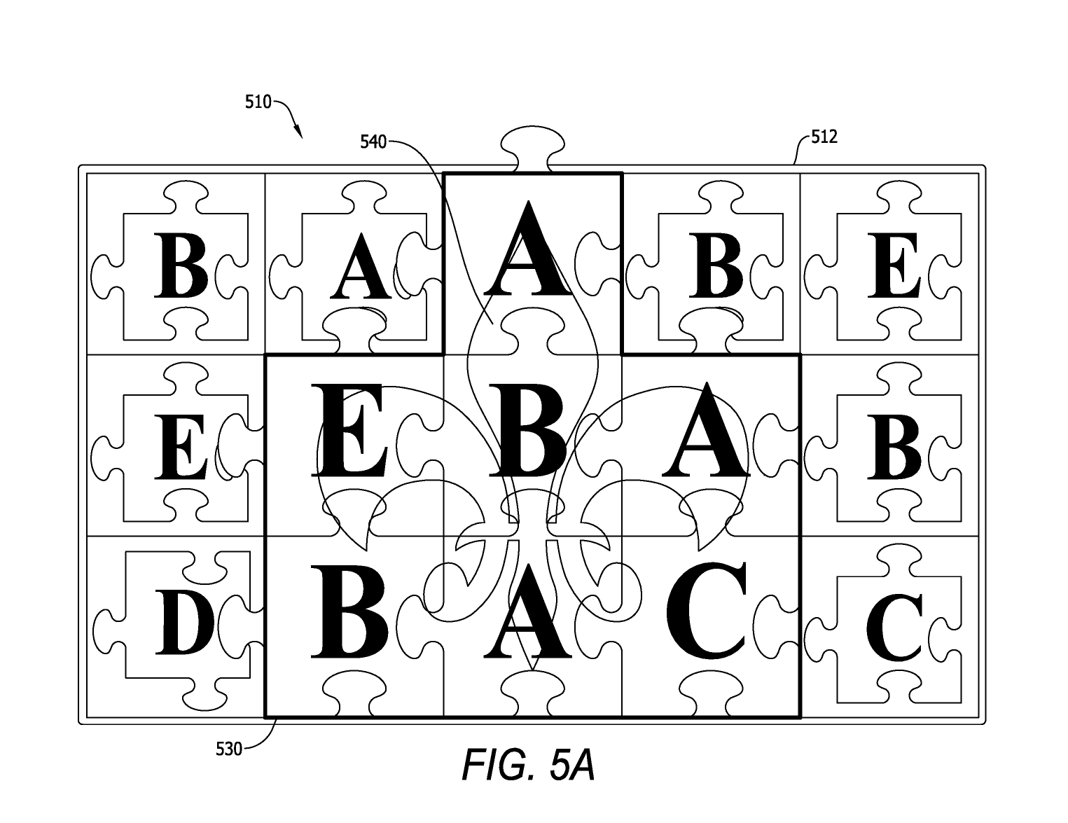

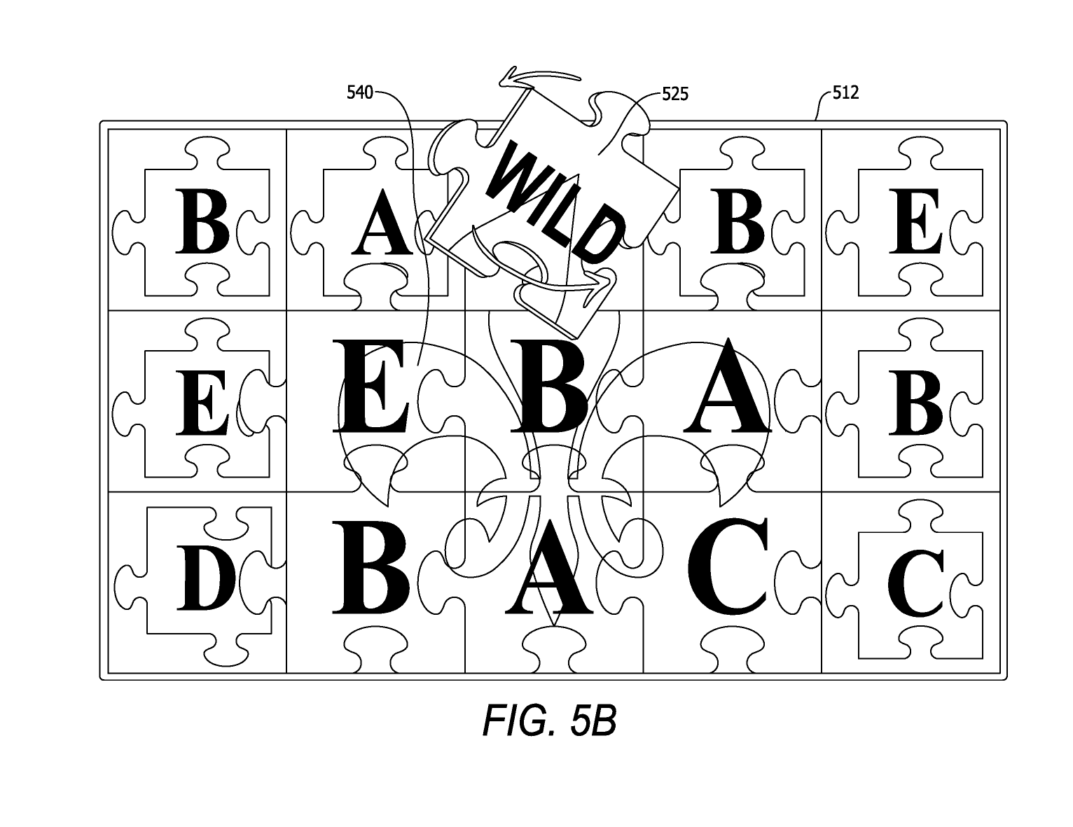

FIG. 5A shows a screen with an array of symbols including a contiguous block of symbols according to one exemplary embodiment. Here, the contiguous block of symbols 530 formed in an array 512 of symbols may comprise different symbols. That is, in FIG. 5A, the symbols forming the block 520 have different primary values. However, the symbols may also have secondarily a part of an image 540. When the different symbols having part of the image 540 align to form the image 540, then the block 530 of symbols is formed. The screen 510 may animate the symbols to connect together to form the image 540. In some instances, in addition to as an alternative to the block 530 changing the symbols to wild symbols, the block 530 forming the image 540 may trigger a bonus game associated with the image 540.

FIG. 5B shows a screen with an array of symbols including a contiguous block of symbols and a wild symbol according to one exemplary embodiment. In some embodiments, wild symbols 525 may also be included in the array 512. The wild symbol 525 may be animated to also attach to the block of symbols to form the single image 540.

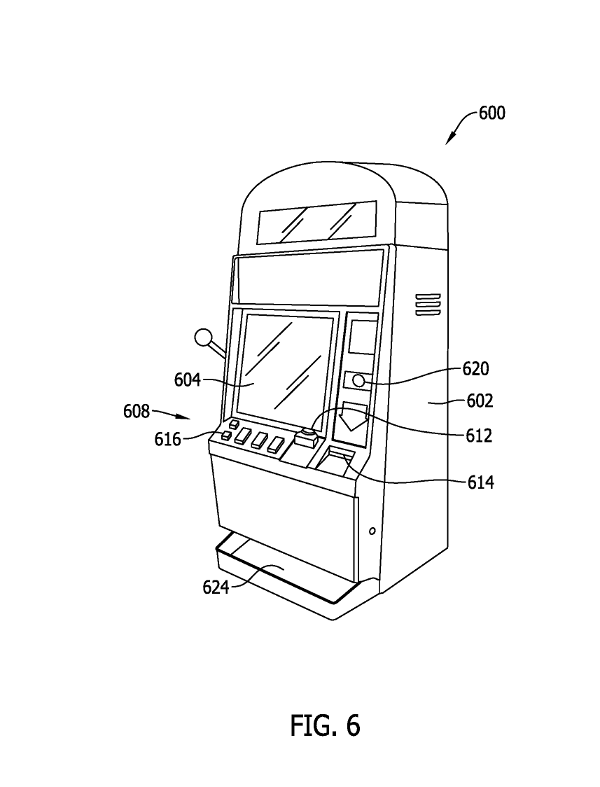

One configuration of a gaming machine 600 is illustrated in FIG. 6. The gaming machine 600, as shown, generally comprises a housing or cabinet 602 for supporting and/or enclosing various components required for operation of the gaming machine. In the embodiment illustrated, the housing 602 includes a door located at a front thereof, the door capable of being moved between an open position which allows access to the interior, and a closed position in which access to the interior is generally prevented. The configuration of the gaming machine 600 may vary. In this embodiment, the gaming machine 600 has an “upright” configuration. However, the gaming machine 600 could have other configurations, shapes or dimensions (such as being of a “slant”-type, “bar-top” or other configuration as is well known to those of skill in the art).

The gaming machine 600 preferably includes at least one display device 604 configured to display game information. The display device 604 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 604 may be capable of projecting or displaying a wide variety of information, including images, symbols and other indicia or information associated with game play, game promotion or other events.

As described in more detail below, the gaming machine 600 is preferably configured to present one or more games upon a player making a monetary payment or wager. In this regard, as described in more detail below, the gaming machine 600 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 600 includes means for returning unused monetary funds and/or dispensing winnings to a player.

The gaming machine 600 preferably includes one or more player input devices 608 (such as input buttons, plunger mechanisms, a touch-screen display, joystick, touch-pad or the like). These one or more devices may be utilized by the player to facilitate game play, such as by providing input or instruction to the gaming machine 600. For example, such input devices 608 may be utilized by a player to place a wager or a side wager, which causes the gaming machine 600 to initiate a game, to indicate cards to be held or discarded, to “cash out” of the gaming machine, or to provide various other inputs. The game and gaming machine disclosed herein may be optionally equipped with a side wager.

In one preferred embodiment, the gaming machine 600 includes at least one microprocessor or controller for controlling the gaming machine, including receiving player input and sending output signals for controlling the various components of the machine 600 (such as generating game information for display by the display 604). The controller may be arranged to receive information regarding funds provided by a player to the gaming machine, receive input such as a purchase/bet signal when a purchase/bet button 616 is depressed, and receive other inputs from a player. The controller may be arranged to generate information regarding a game, such as generating game information for display by the at least one display 604 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 600 may also include one or more random number generators for generating random numbers, such as for use in selecting cards and for presenting the game in a random fashion.

Preferably, the controller, such as a processor, is configured to execute machine readable code or instructions which are configured to implement the method of game play of the invention. For example, the controller of the gaming machine 600 may be configured to detect a wager, such as a signal from a player's depressing of the “bet one” button. Upon such an event and/or the player otherwise signaling the gaming machine to present the game, the controller may be configured to cause cards to be dealt/displayed on the at least one display 604. The controller may accept input from a player of a request to split, buy insurance, obtain additional cards, activate slot reels, or the like via the one or more player input devices 608 of the gaming machine 600.

The gaming machine 600 may be configured to generate and present games in a stand-alone manner or it may be in communication with one or more external devices at one or more times. For example, the gaming machine 600 may be configured as a server based device and obtain game code or game outcome information from a remote game server (in which event the gaming machine controller may receive game information from the server, such as game outcome information, and use that server-generated information to present the game at the gaming machine).

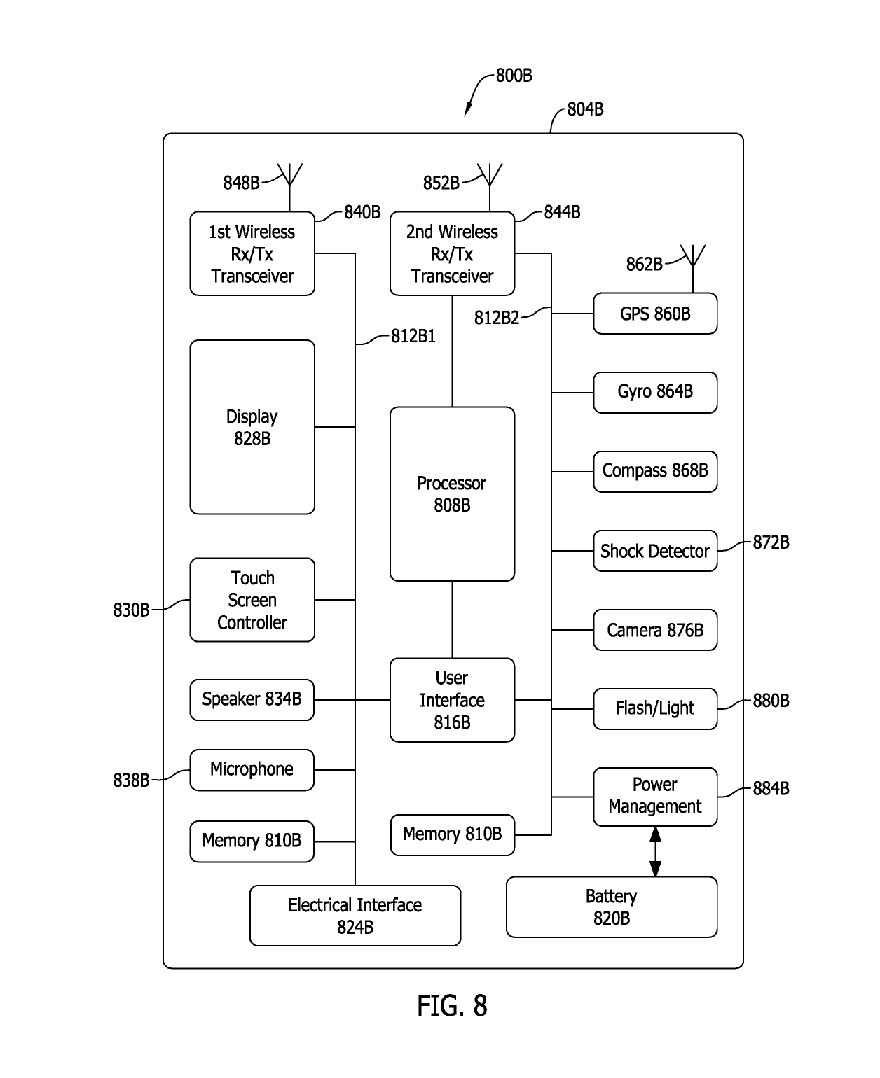

As indicated, the gaming machine 600 is configured to present one or more wagering games. Thus, the gaming machines 600 is preferably configured to accept value, such as in the form of coins, tokens, paper currency or other elements or devices representing value such as monetary funds. For example, as illustrated in FIG. 8, the gaming machine 600 might include a coin acceptor 612 for accepting coins. Of course, associated coin reading/verifying devices and coin storage devices may be associated with the gaming machine 600 if it is configured to accept coins. Likewise, the gaming machine 600 might include a media reader 614. Such a reader may be configured to accept and read/verify paper currency and/or other media such as tickets. Of course, in such event the gaming machine 600 may further be configured with one or more paper currency or ticket storage devices, such as cash boxes, and other paper currency or media handling devices (including transport devices).

The gaming machine 600 might also be configured to read FOBs, magnetic stripe cards or other media having data associated therewith and via which value or funds may be associated with the gaming machine 600.

In one embodiment, the gaming machine 600 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 600 dispensing coins to a coin tray 624. In another embodiment, funds may be issued by dispensing paper currency. In yet another embodiment, a player may be issued a media, such as a printed ticket, such that the ticket represents the value which was paid or cashed out of the machine.

The gaming machine 600 may also include a player tracking device, such as a card reader and associated keypad 620. Such player tracking devices are well known and may permit the game operator to track play of players of the gaming machine. The tracked play may be utilized to offer player bonuses or awards.

It will be appreciated that the gaming machine illustrated in FIG. 6 is only exemplary of one embodiment of a gaming machine. For example, it is possible for the gaming machine to have various other configurations, including different shapes and styles and having different components than as just described.

For example, it is possible for the base game to be presented on a computing device, including at a home or office computer, a kiosk or other types of devices. For example, the game might be presented via an application running on a computing device, or in a server-based or “Internet” environment. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

A casino may have numerous such gaming machines 600, such as located on a casino floor or in other locations. Of course, such gaming machines 600 might be used in other environments, such as an airport, a bar or tavern or other locations.

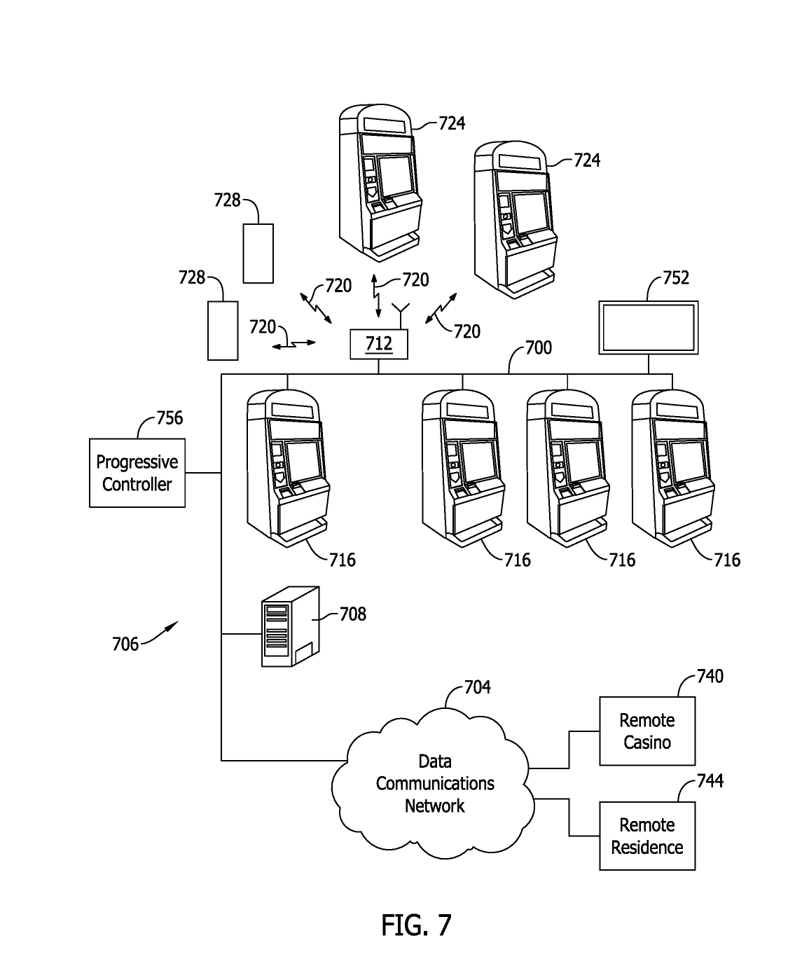

FIG. 7 is a block diagram of an example gaming system with a server based network. The communications network 700, 704 connects to multiple devices as discussed below to enable communication between devices. The network 700, 704 may be any type network capable of exchanging data between devices. The network may include a local network 700 and an external network 704 such as for example the Internet, or an Intranet with appropriate security mechanisms. The wagering game network may include other network devices, such as one or more servers which may comprise accounting servers, wide area progressive servers, player tracking servers, game content servers, or any other type server.

In this embodiment the gaming establishment at the top of the figure includes a network 700. As shown, the gaming network includes gaming machines 716 connected to the network 700 via a wired connection.

The network 700 may include a wireless device 712 capable of communicating over a wireless link 720 with one or more wireless gaming machines 724 or hand held gaming devices 728 A wagering game server 708 may serve wagering games on the gaming machines over the local area network 700 and function as a remote controller for the wagering games as described above.

The wagering network includes hardware and memory storing machine readable instructions and machine readable code for performing the operations described herein. Those of ordinary skill in the art will appreciate that each gaming establishment may include additional local area networks such which may serve to connect many other wagering games. Alternatively, multiple servers 708 may be used for the functions of the wagering game server which provide game content to the gaming machines 716, 724, 728.

The local area network 706 may be any type of suitable property LAN configuration including, for example, a dedicated hardwired property LAN or a wireless property LAN. The local area network 706 may be configured in any configuration or topology.

The local area network 706 includes wired communication links 700 and wireless communication links 720. In this example configuration, the stand-alone gaming machines 716 communicate with the network 702, 708 via the wired communication links as shown. The stand-alone gaming machines 728 as well as the handheld gaming devices 728 communicate with the network 700, 708 via the wireless communication links 720. One or more wireless communication devices 712, with associated antennas, enables wireless communication. Other combinations of wired and wireless connections to different gaming machines may be used. The wired and wireless communication links may employ any suitable connection protocols such as Bluetooth, IEEE 802.11, Ethernet, or any other format or standard. The network 700, 708 may be configured to enable downloading of instruction sets (software) for games, game configuration data, game outcomes, from the central server(s) such as the server 708 to the gaming machines, and to enable uploading or downloading of marketing and operations data from the gaming terminals to the central server.

As shown at the bottom of FIG. 7, the game server 708 or network 700 may also serve wagering game devices and/or distribute content to devices located in other gaming establishment 740 or at other locations 744 such as a residence.

The server 708 may be any type computer capable of executing programs or instruction sets for controlling gaming machine, such as slot machines, video slots, or video poker machines, and communication with wireless devices. Although shown as a single server, numerous servers may be used. In such embodiments, the gaming machines 716, 724, 728 may each be a simple input/output terminal with regard to the functions controlled by the server 708. For example, the random selection of outcomes for the basic game and any bonus game may be functions performed by the server 708 and subsequently provided to a gaming machine. Functions that are not provided by the server 708, such as control of the local lights, sounds, and displays of the gaming machine, are handled by the local CPU within the gaming machine.

In this embodiment, a progressive or accumulated jackpot system is provided that includes a video or other type display 752 that is coupled to the network 700, 708. The display 752 is viewable by a number of players to present a total jackpot that is available for award upon receipt of a predetermined outcome. This type event may be referred to as community based events accessible from games on the gaming machines or from remote locations 740, 744 or gaming devices 728. For example, the display 752 may be used to show a current progressive jackpot or jackpots which players playing different gaming machines may be eligible to win. The display 752 may be any type display.

In one embodiment, the community event is a progressive award or jackpot, which is preferably linked with other gaming machines via the network 700, 708 and/or the network 704. The entire progressive award or jackpot may be won upon the occurrence of a certain outcome of the game.

The server 708 may also operate one or more progressive awards concurrently with the basic game and/or bonus games. As explained above, such progressive awards are funded by appropriating a percentage of the coin-in from participating gaming machines. To be eligible to win the progressive award, the player may be required to make a progressive award side wager or make a wager satisfying predetermined criteria, e.g., a maximum wager or a wager covering all available pay-lines in the basic game. Then, upon occurrence of jackpot-won event in the form of either a “mystery” event or one or more predetermined outcomes in the basic game and/or bonus game, the player is awarded the progressive jackpot in addition to any regular prize or award resulting from the basic game and/or bonus game. The jackpot-won event may, for example, be the appearance of a predetermined scatter symbol during the basic game. A basic game menu may be part of the game disclosed herein and include several options for a player, including picking games, progressive options, and side bet options. Other community events may include a community bonus game, a bonus prize shared by multiple players, a multiplier award or other community features. Such a community event may interrupt the game play on the gaming machine 716 and use other mechanisms such as the display 752 to show graphics or video relating to the community event. In this example embodiment, each one of the players who are currently playing wagering games on the gaming machines participates in the community event according to an eligibility criteria such as time-based eligibility that each gaming machine determines locally. In this example, a community event or progressive controller 756 associated with the display 752 and progressive system continuously runs a process to determine if the community bonus should occur, using its random number generator (RNG) and monitor coin-in or wagers to increment the amount on the display. For example, controller 756 determines if the community event is triggered. If the controller 765 determines that the community event is triggered or won, then it will issue an invitation to the gaming machines. Because each of the wagering games on the gaming machines keeps track of the current eligibility of the respective games being played, each of the gaming machines makes a decision whether it will allow the player to participate in the community event, and at which multiplier any bonuses or prizes resulting from the community event will be awarded to the player. It is to be understood that a server such as the server 708 or a master gaming machine may be used for the controller 756.

The server 708 includes a storage device that contains software instruction sets for different wagering games which may be loaded onto a memory of gaming machines. It is to be understood that different parts of the instruction sets may be stored on the memory with other parts of the instruction sets stored on the individual gaming machines. For example, the gaming machines may store part of the instruction sets in the form of modules relating to graphics files, audio/sound files, and certain game functions and operations such as player greetings or instructions. The stored instructions sets are mated with the remainder of the instruction sets loaded from the memory over the network 700.

Part or all of the software instruction set for wagering games may be sent to the various gaming machines via the wired communication links 700 or the wireless communication links 720. The wagering games may be stand alone or may offer eligibility or access to progressive awards or support other community events with other gaming machines on the network 700 or external networks 704.

The server 708 in this example stores a number of wagering games in the storage device. It is to be understood that part of the software to support the wagering games may already reside on the system memory of the gaming machine. For example, the modules responsible for RNG, audio and/or video drivers, etc. may reside on the system memory of the gaming machine. Other components of the instruction set of the game such as graphics files, audio files etc. may also reside in the storage device. Some or all of the instruction set may be loaded via the external I/O circuit from the network 700 such as from the storage device of the server 708. In this manner, the gaming machine may be used to play different games without requiring manual delivery of instruction sets different games to the gaming machine.

For example, a player may request a certain wagering game based on an initial display of a menu of wagering games displayed by the gaming machine. The menu may include some or all available wagering games stored on the server 708. Other background graphics and/or videos may be displayed on the primary display or the secondary display of the gaming machine to attract players to the gaming machine. The secondary display may be electronic or a secondary game to present a secondary game outcome. Based on the menu displayed, a player may select the desired game via a player input device such as push buttons or touch screen buttons. Further, an operator of the casino may use the server 714 to load wagering games to different gaming machines based on popularity, location, time interval, special events, schedule, etc.

FIG. 8 is an exemplary computer or mobile device 800B. FIG. 8 illustrates an example embodiment of a mobile device 800B. This is but one possible device configuration, and as such it is contemplated that one of ordinary skill in the art may differently configure the mobile device. The device 800B may comprise any type of fixed or mobile communication device that can be configured in such a way so as to function as described below. The mobile device may comprise a PDA, cellular telephone, smart phone, tablet PC, wireless electronic pad, or any other computing device. The components shown in FIG. 8 may also include the components shown in FIG. 6 and the components of FIG. 6 may also be included in the system of FIG. 8.

In this example embodiment, the mobile device 800B is configured with an outer housing 804B that protects and contains the components described below. Within the housing 804B is a processor 808B and a first and second bus 812B1, 812B2 (collectively 812B). The processor 808B communicates over the buses 812B with the other components of the mobile device 800B. The processor 808B may comprise any type of processor or controller capable of performing as described herein. The processor 808B may comprise a general purpose processor, ASIC, ARM, DSP, controller, or any other type processing device.

The processor 808B and other elements of the mobile device 800B receive power from a battery 820B or other power source. An electrical interface 824B provides one or more electrical ports to electrically interface with the mobile device 800B, such as with a second electronic device, computer, a medical device, or a power supply/charging device. The interface 824B may comprise any type of electrical interface or connector format.

One or more memories 810B are part of the mobile device 800B for storage of machine readable code for execution on the processor 808B, and for storage of data, such as image data, audio data, user data, medical data, location data, shock data, or any other type of data. The memory may store the messaging application (app). The memory may comprise RAM, ROM, flash memory, optical memory, or micro-drive memory. The machine readable code as described herein is non-transitory.

As part of this embodiment, the processor 808B connects to a user interface 816B. The user interface 816B may comprise any system or device configured to accept user input to control the mobile device. The user interface 816B may comprise one or more of the following: keyboard, roller ball, buttons, wheels, pointer key, touch pad, and touch screen. A touch screen controller 830B is also provided which interfaces through the bus 812B and connects to a display 828B.

The display comprises any type of display screen configured to display visual information to the user. The screen may comprise an LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 828B receives signals from the processor 808B and these signals are translated by the display into text and images as is understood in the art. The display 828B may further comprise a display processor (not shown) or controller that interfaces with the processor 808B. The touch screen controller 830B may comprise a module configured to receive signals from a touch screen which is overlaid on the display 828B. Messages may be entered on the touch screen 830B, or the user interface 816B may include a keyboard or other data entry device.

Also part of this exemplary mobile device is a speaker 834B and microphone 838B. The speaker 834B and microphone 838B may be controlled by the processor 808B and are configured to receive and convert audio signals to electrical signals, in the case of the microphone, based on processor control. Likewise, processor 808B may activate the speaker 834B to generate audio signals. These devices operate as is understood in the art and as such are not described in detail herein.

Also connected to one or more of the buses 812B is a first wireless transceiver 840B and a second wireless transceiver 844B, each of which connect to respective antenna 848B, 852B. The first and second transceiver 840B, 844B are configured to receive incoming signals from a remote transmitter and perform analog front end processing on the signals to generate analog baseband signals. The incoming signal may be further processed by conversion to a digital format, such as by an analog to digital converter, for subsequent processing by the processor 808B. Likewise, the first and second transceiver 840B, 844B are configured to receive outgoing signals from the processor 808B, or another component of the mobile device 808B, and up-convert these signal from baseband to RF frequency for transmission over the respective antenna 848B, 852B. Although shown with a first wireless transceiver 840B and a second wireless transceiver 844B, it is contemplated that the mobile device 800B may have only one such system or two or more transceivers. For example, some devices are tri-band or quad-band capable, or have Bluetooth and NFC communication capability.

It is contemplated that the mobile device, and hence the first wireless transceiver 840B and a second wireless transceiver 844B may be configured to operate according to any presently existing or future developed wireless standard including, but not limited to, Bluetooth, WI-FI such as IEEE 802.11a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the mobile device is one or more systems connected to the second bus 812B which also interfaces with the processor 808B. These devices include a global positioning system (GPS) module 860B with associated antenna 862B. The GPS module 8160B is capable of receiving and processing signals from satellites or other transponders to generate location data regarding the location, direction of travel, and speed of the GPS module 860B. GPS is generally understood in the art and hence not described in detail herein.

A gyro 864B connects to the bus 812B to generate and provide orientation data regarding the orientation of the mobile device 804B. A compass 868B, such as a magnetometer, provides directional information to the mobile device 804B. A shock detector 872B, which may include an accelerometer, connects to the bus 812B to provide information or data regarding shocks or forces experienced by the mobile device. In one configuration, the shock detector 872B generates and provides data to the processor 808B when the mobile device experiences a shock or force greater than a predetermined threshold. This may indicate a fall or accident.

One or more cameras (still, video, or both) 876B are provided to capture image data for storage in the memory 810B and/or for possible transmission over a wireless or wired link or for viewing at a later time. The processor 808B may process image data to perform image recognition, such as in the case of, facial detection, item detection, facial recognition, item recognition, or bar/box code reading.

A flasher and/or flashlight 880B are provided and are processor controllable. The flasher or flashlight 880B may serve as a strobe or traditional flashlight, and may include an LED. A power management module 884 interfaces with or monitors the battery 820B to manage power consumption, control battery charging, and provide supply voltages to the various devices which may require different power requirements.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method of presenting a game at a gaming machine comprising at least one electronic display, a wager accepting device configured to accept a physical item representing a monetary value, at least one input device, at least one memory, and at least one processor configured to execute machine readable instructions stored on the memory, the method comprising:
accepting a wager from a player via the wager accepting device;
displaying a plurality of symbols in an array of symbols on the electronic display, the array of symbols comprising symbol positions aligned in rows and columns;
determining whether two or more of the plurality of symbols displayed in the array of symbols are the same symbol and are disposed adjacent to one another defining a common symbol block;
when the two or more of the plurality of symbols define a common symbol block, replacing the two or more symbols with a first replacement symbol;
evaluating pay lines on the array of symbols to determine whether the array of symbols including the first replacement symbols define winning outcomes.

2. The method of claim 1, wherein the first replacement symbol is a wild symbol.

3. The method of claim 1, wherein the common symbol block is defined by the same symbols that are adjacent to one another in a horizontal and vertical direction in the array.

4. The method of claim 1, wherein the two or more symbols defining a common symbol block trigger a secondary event comprising at least one of a bonus game, a progressive jackpot, and one or more free spins.

5. The method of claim 1, further comprising when the two or more symbols define a common symbol block, holding the two or more symbols in the array and respinning remaining symbols within the array to randomize the remaining symbols from the plurality of symbols.

6. The method of claim 5, further comprising evaluating the remaining symbols to determine if the remaining symbols comprise the same symbol adjacent to the common symbol block, and adding the same symbol to the common symbol block when the remaining symbols comprise the same symbol adjacent to the common symbol block.

7. The method of claim 1, further comprising when the two or more symbols do not define the common symbol block, changing one or more selected symbols from the displayed plurality of symbols to change the selected symbols into a different symbol to form the common symbol block.

8. The method of claim 1, wherein when two or more common symbol blocks are formed in the array, the two or more common symbol blocks are moved to form a single common symbol block.

9. The method of claim 1, further comprising when the two or more symbols define the common symbol block, increasing a size of the array of symbols.

10. The method of claim 9, wherein the size of the array of symbols is increased in a vertical direction corresponding to the location of the common symbol block.

11. The method of claim 1, wherein the display shows the two or more symbols connecting to appear as a continuous symbol.

12. A method of presenting a game at a gaming machine comprising at least one electronic display, a wager accepting device configured to accept a physical item representing a monetary value, at least one input device, at least one memory, and at least one processor configured to execute machine readable instructions stored on the memory, the method comprising:
accepting a wager from a player via the wager accepting device;
displaying a plurality of symbols in an array of symbols on the electronic display, the array of symbols comprising symbol positions aligned in rows and columns, the plurality of symbols comprising a primary value and a secondary design;
determining whether two or more of the plurality of symbols displayed in the array of symbols are disposed adjacent to one another such that a combination of the secondary design of the two or more symbols forms a predetermined image;
when the two or more of the plurality of symbols form the predetermined image, replacing the two or more symbols with a first replacement symbol;
evaluating pay lines on the array of symbols to determine whether the array of symbols including the first replacement symbols define winning outcomes.

13. The method of claim 12, wherein the first replacement symbol is a wild symbol.

14. The method of claim 12, wherein the two or more symbols comprise different primary values.

15. The method of claim 12, wherein the two or more symbols the predetermined image trigger a secondary event comprising at least one of a bonus game, a progressive jackpot, and one or more free spins.

16. The method of claim 12, further comprising when the two or more symbols do not form the predetermined image, receiving an input from the player to change one or more selected symbols from the displayed plurality of symbols to change the selected symbols into a different symbol to form the predetermined image.

17. The method of claim 12, wherein when two or more predetermined images are formed in the array, the two or more predetermined images are moved to form a single image.

18. The method of claim 12, further comprising when the two or more symbols form the predetermined image, increasing a size of the array of symbols.

19. The method of claim 12, wherein the display shows the two or more symbols connecting to appear as a continuous symbol.

20. A gaming machine comprising:
a wager accepting device comprising a coin, bill, or ticket acceptor configured to receive a monetary value at the gaming machine;
at least one electronic display configured to present game information including a wagering 5 game to a player;
at least one player input device that is part of or separate from the display, the player input device configured to accept player input regarding the wagering game;
a controller including one or more random number generators in communication with the player input device, the controller configured to execute machine-readable code;
memory in communication with the controller, the memory configured to store the machine-readable code, the machine readable code executable by the controller and configured to cause the gaming machine to present a wagering game comprising:
receiving a coin, bill, or ticket comprising a monetary value from the player at the gaming machine as credits usable at the gaming machine;
accepting an input from the player via the at least one player input device to accept a wager on a wagering game or enable game play;
presenting a plurality of slot reels on the electronic display, the plurality of slot reels each comprising a plurality of symbols;
displaying a plurality of symbols in an array of symbols on the electronic display;
determining whether two or more of the plurality of symbols displayed in the array of symbols are the same symbol and are located adjacent to one another defining a common symbol block;
when the two or more of the plurality of symbols define a common symbol block, replacing the two or more symbols with a first replacement symbol;
evaluating pay lines on the array of symbols to determine whether the array of symbols including the first replacement symbols define winning outcomes; and
upon the occurrence of a winning outcome, providing an award to the player, the award comprising or redeemable for coins, bills, or a ticket.
